(19) United States
(12) Patent Application Publication
(10) Pub. No.: US 2026/0208834 A1
(43) Pub. Date: Jul. 23, 2026

(54) UNDERWATER ROBOTS FOR AUTONOMOUS POWER MANAGEMENT

(71) Applicant: INTERNATIONAL BUSINESS MACHINES CORPORATION, ARMONK, NY (US)

(72) Inventors: Michael Boone, Lutz, FL (US); Sarbajit Kumar Rakshit, Kolkata (IN); Carolina Garcia Delgado, Zapopan (MX); Randy A. Rendahl, Raleigh, NC (US)

(21) Appl. No.: 19/034,518

(22) Filed: Jan. 22, 2025

(51) Int. Cl. B63G 8/08; B63G 8/00; G05D 1/69; H01M 8/16; G05D 107/00; G05D 109/30

(52) U.S. Cl. CPC B63G 8/08; B63G 8/001; G05D 1/69; H01M 8/16; B63G 2008/004; G05D 2107/25; G05D 2109/38; H01M 2250/20

(57) ABSTRACT

An underwater robotic system includes one or more underwater robots, one or more microbial power generation modules, and a processor that determines a power demand for an underwater robot to perform an underwater activity; selects one or more microbial power generation modules based on a proximity of the microbial power generation modules to the one or more underwater robots and a capability of one or more microbial power generation modules to provide the power demand; and cause the underwater robot to couple with the selected one or more microbial power generation module to receive power while performing the underwater activity.

### BACKGROUND

### Technical Field

The present disclosure generally relates to systems and methods for operating underwater robots in wastewater environments.

### Description of the Related Art

Wastewater treatment is an essential process for mitigating the environmental impact of effluents produced by various industries, including chemical manufacturing, petroleum refining, food processing, and metalworking. Wastewater treatment methods, such as the activated sludge process, involve the aeration of wastewater to promote the growth of microorganisms that degrade organic pollutants. These methods are energy-intensive and generate significant volumes of excess sludge, necessitating further treatment and disposal.

### BRIEF SUMMARY

According to an embodiment of the present disclosure, an underwater robotic system includes one or more underwater robots, one or more microbial power generation modules, and a processor that determines a power demand for an underwater robot to perform an underwater activity and selects a microbial power generation module based on a proximity of the microbial power generation modules to the one or more underwater robots and a capability of one or more microbial power generation modules to provide the power demand. The system then causes the underwater robot to couple with the selected one or more microbial power generation module to receive power while performing the underwater activity.

In one embodiment, the underwater robots evaluate whether to carry the microbial power generation modules or install the microbial power generation modules at optimal locations within the wastewater environment based on factors such as power generation rate and weight of the microbial power generation module coupled to the underwater robot.

In one embodiment, the underwater robots are configured to identify and select the microbial power generation modules for recharging based on the stored power levels, power generation rates, and proximity.

According to an embodiment of the present disclosure, a method of operating one or more underwater robots in a wastewater environment includes deploying the underwater robots and a plurality of microbial power generation modules within the wastewater environment, determining a power demand to perform a plurality of activities, selecting one or more microbial power generation modules based on a proximity metric and a capability metric to provide the power demand and coupling with the selected microbial power generation modules to receive power while performing the activities.

According to an embodiment of the present disclosure, a computer program product for managing operations of a plurality of underwater robots in a wastewater environment includes one or more computer-readable storage devices and program instructions stored on the at least one of the one or more computer-readable storage devices. The program instructions are executable by one or more processors of the robots, the program instructions include program instructions to deploy the plurality of underwater robots and a plurality of microbial power generation modules within the wastewater environment. The program instructions include program instructions to determine a power demand for an underwater robot of the plurality of underwater robots to perform an underwater activity of the plurality of underwater activities. The program instructions include program instructions to select one or more microbial power generation modules based on at least a proximity of the one or more power generation modules to the underwater robot and a capability of the one or more microbial power generation modules to provide the power demand. The program instructions include program instructions to couple the underwater robot with the selected one or more microbial power generation modules to receive power while performing the underwater activity.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a block diagram of a network of data processing systems in accordance with an illustrative embodiment.

FIG. 2 depicts a block diagram of a computing environment in accordance with an illustrative embodiment.

FIG. 3 depicts a block diagram of an underwater robotic system in accordance with an illustrative embodiment.

FIG. 4 depicts a microbial fuel cell of a microbial power generation module in accordance with an illustrative embodiment.

FIG. 5 depicts a navigation operation of the underwater robotic system in accordance with an illustrative embodiment.

FIG. 6 depicts a recharging operation of the underwater robotic system in accordance with an illustrative embodiment.

FIG. 7 depicts a flowchart of a method of operating one or more robots in a wastewater environment in accordance with an illustrative embodiment

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to systems and methods for operating underwater robots for cleaning wastewater. Wastewater cleaning methods, such as the active sludge process, are used to treat industrial wastewater before the industrial wastewater is released into the environment. While effective in improving water quality, these methods can consume significant amounts of energy, leading to high CO2 emissions due to power consumption for aeration and the treatment of excess sludge. Additionally, buildup of precipitated calcium and magnesium salts can cause severe blockages in pipes, complicating the treatment process. It is recognized that although microbial fuel cell (MFC) technology offers a sustainable alternative by using microorganisms to both decompose organic matter in wastewater and generate electricity through microbial, practical application may be limited due to, for example, efficiency in wastewater treatment, efficiency in power generation, long-term maintenance for stable performance, and scale. The illustrative embodiments disclose an underwater robotic system designed to efficiently perform various underwater activities in wastewater environments while optimizing power availability using microbial power generation modules. The underwater robotic system enables one or more underwater robot to autonomously manage power needs by dynamically selecting and coupling with nearby microbial power generation modules that generate electricity through microbial electrogenesis.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Example Data Processing Environment

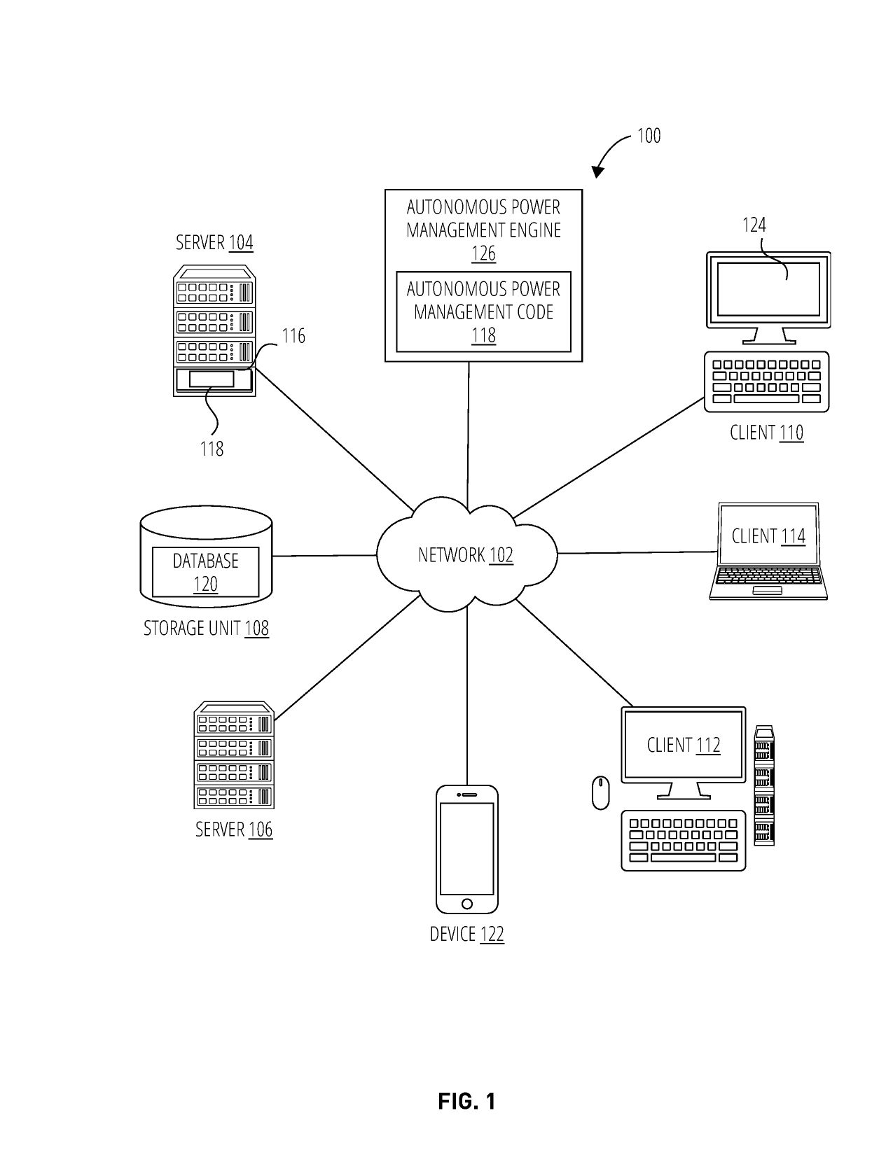

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), autonomous power management engine 126 (which may be centralized outside an underwater robot or may reside in or more underwater robots) and device 122 may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system, which are all within the scope of the illustrative embodiments. One or more of the components may be waterproof.

Data processing systems (autonomous power management engine 126, server 104, server 106, client 110, client 112, client 114, device 122) also represent example nodes in a cluster, partitions, and other configurations suitable for implementing an embodiment.

Server 104, server 106, storage unit 108, client 110, client 112, client 114, device 122, autonomous power management engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or autonomous power management engine 126 may include autonomous power management code 118, which is configured for the automated management of power generation in a wastewater environment using microbial fuel cells and one or more underwater robots. In some embodiments, the autonomous power management engine 126 may be, or form a part of, a server or client as described herein.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store one or more term data samples for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as autonomous power management code 118. In addition to autonomous power management code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214(including operating system 216 and autonomous power management code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

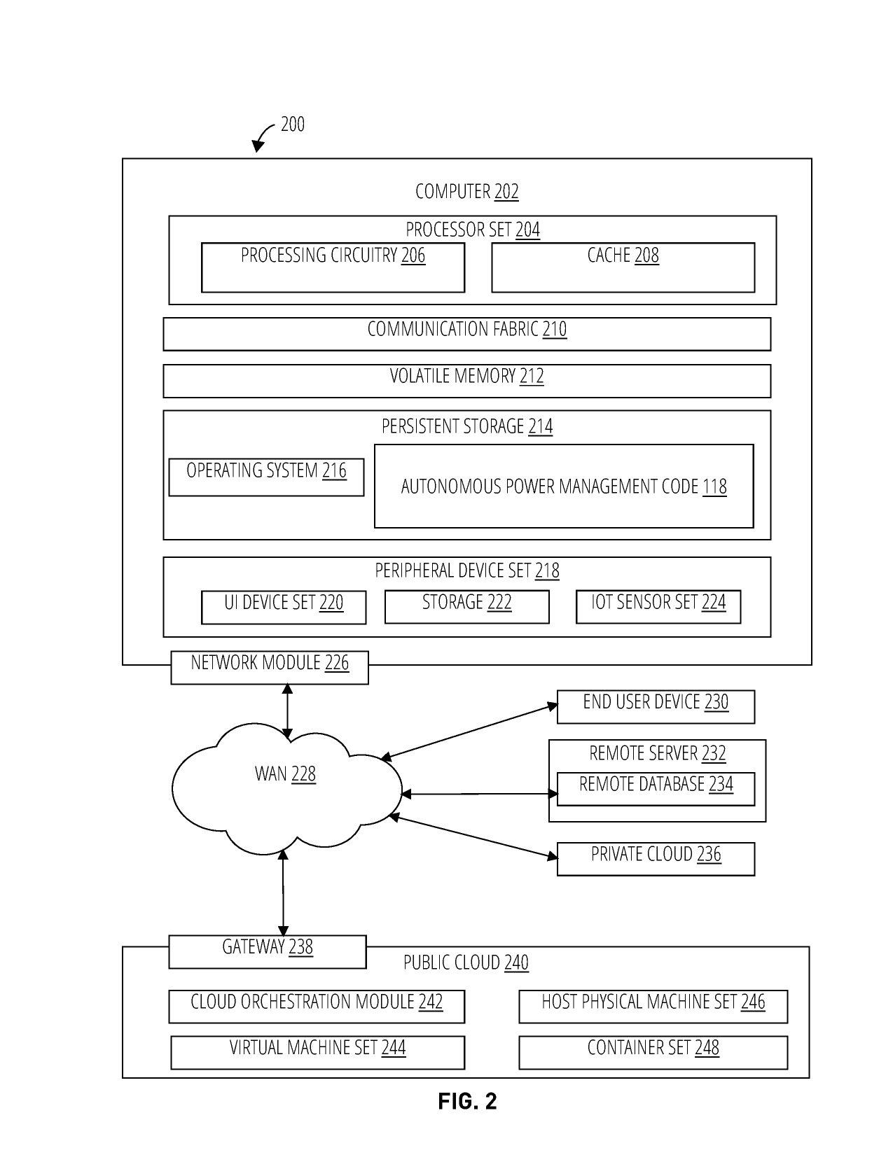

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer- implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in autonomous power management code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in autonomous power management code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on- demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

### Example Architecture

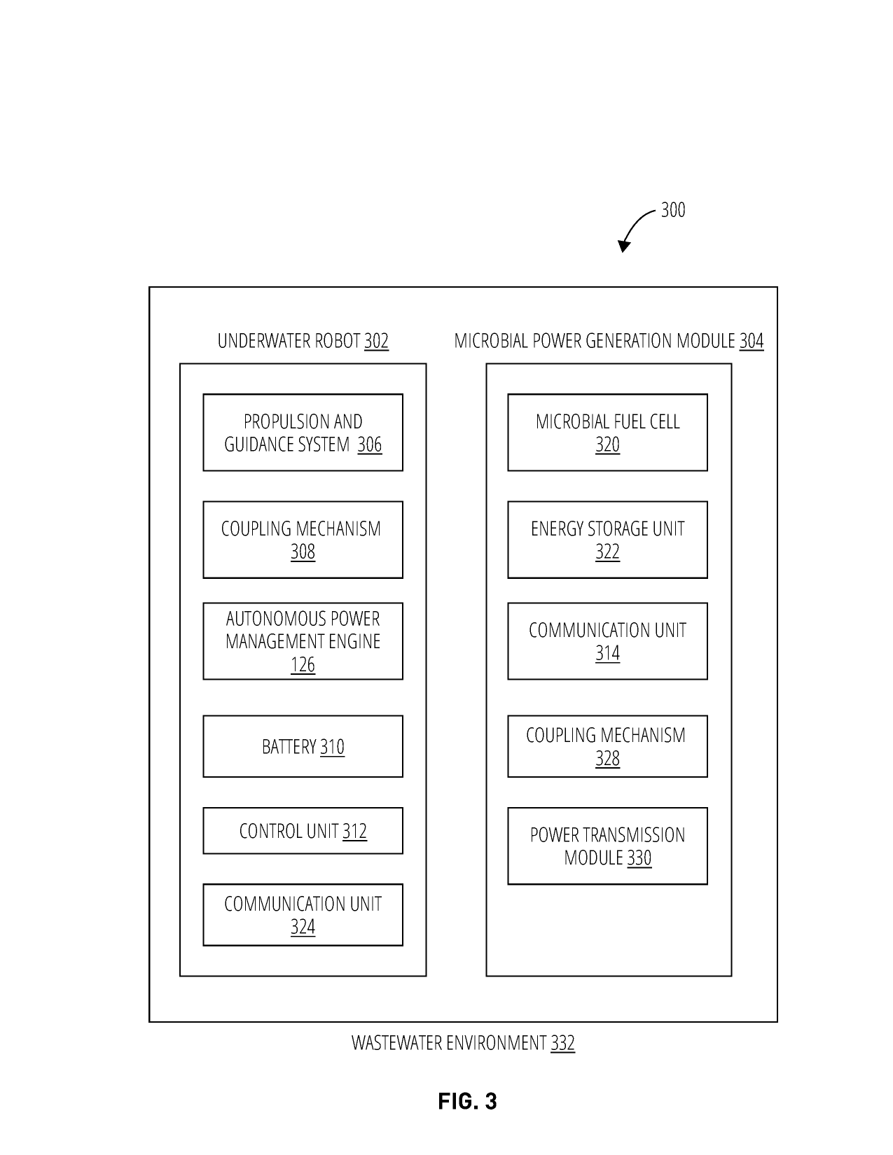

Reference is now made to FIG. 3, which illustrates a block diagram of an underwater robotic system 300 in accordance with one or more embodiments of the present disclosure. The underwater robotic system 300 includes one or more underwater robots 302 configured to perform various activities (such as various underwater activities including removing sedimentation, cleaning blockages, and creating vortex flows on the wastewater to prevent sedimentation) in a wastewater environment 332. The system further includes one or more microbial power generation modules 304 operatively associated with the underwater robots 302.

The underwater robot 302 includes a processor or control unit 312 which is configured to generate information about an amount of power that can be used to power the underwater robot 302 (a power demand) to perform one or more activities. The underwater robot 302 selects one or more microbial power generation modules 304 based on a proximity metric quantifying a proximity of the underwater robot 302 to a microbial power generation module 304. The underwater robot 302 may also in addition perform the selection based on an ability (a capability) of the microbial power generation module 304 to provide a power demand for the underwater robot 302 and the underwater robot 302 may navigate through the wastewater using a propulsion and guidance system 306 configured to drive the underwater robot 302 to one or more locations. The underwater robot 302 couples with the selected microbial power generation modules 304 using a coupling mechanism 308 that can receive power while performing the activities, enabling the underwater robot 302 to maintain continuous operation underwater without having to surface for recharging the battery 310, thereby enhancing efficiency and resource management.

In an embodiment, the underwater robot 302 is configured to evaluate, based on a power generation rate (rate at which power is being, or can be generated by an underwater microbial power generation module 304) and/or a weight of the coupled microbial power generation modules 304, whether to carry the microbial power generation modules 304 or to place the microbial power generation modules at selected locations within the wastewater environment 332 to optimize power availability. Carrying a microbial power generation module 304 provides continuous power supply but may increase the overall weight of the underwater robot 302, affecting mobility and increasing power consumption. Placing the microbial power generation modules 304 at optimal locations can maximize power generation without burdening the underwater robots 302. The evaluation may be performed by executing the autonomous power management code 118 using the autonomous power management engine 126, which allows the underwater robots 302 to make intelligent decisions that enhance operational efficiency.

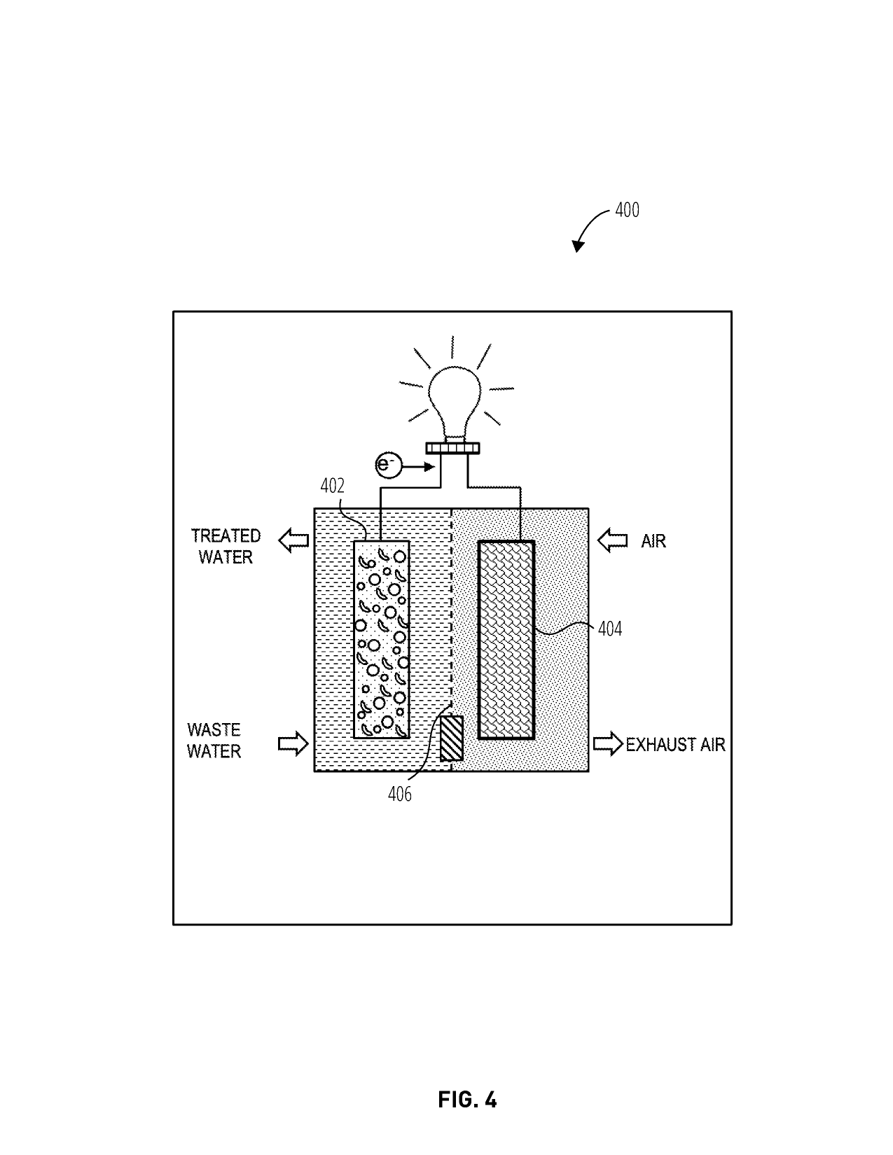

FIG. 4 depicts a microbial fuel cell 400 of a microbial power generation module 304 in accordance with an illustrative embodiment. The microbial power generation module 304 may generate electricity through microbial electrogenesis by oxidizing organic matter present in the wastewater environment. Each module can include one or more microbial fuel cells (MFC) 320 containing an anode 402 and a cathode 404 separated by a membrane 406. Microorganisms colonize the anode, metabolizing organic compounds in the wastewater and releasing electrons. These electrons flow through an external circuit to the cathode, creating an electric current. The amount of electricity produced depends on factors such as the type of microorganisms, the characteristics of the wastewater, and the design of the MFC system.

Turning back to FIG. 3, the microbial power generation modules 304 generate power through microbial electrogenesis by oxidizing organic matter present in the wastewater environment 332. Each microbial power generation module 304 includes a microbial fuel cell 320 that generates electricity through the metabolic activity of microorganisms. The modules 304 include an energy storage unit 322 configured to store the generated power and a communication unit 314 configured to transmit stored power levels and real-time or streaming power generation rates to the underwater robots 302. The transmission allows the underwater robots 302 to assess the availability of power before selecting a microbial power generation module 304 for recharging.

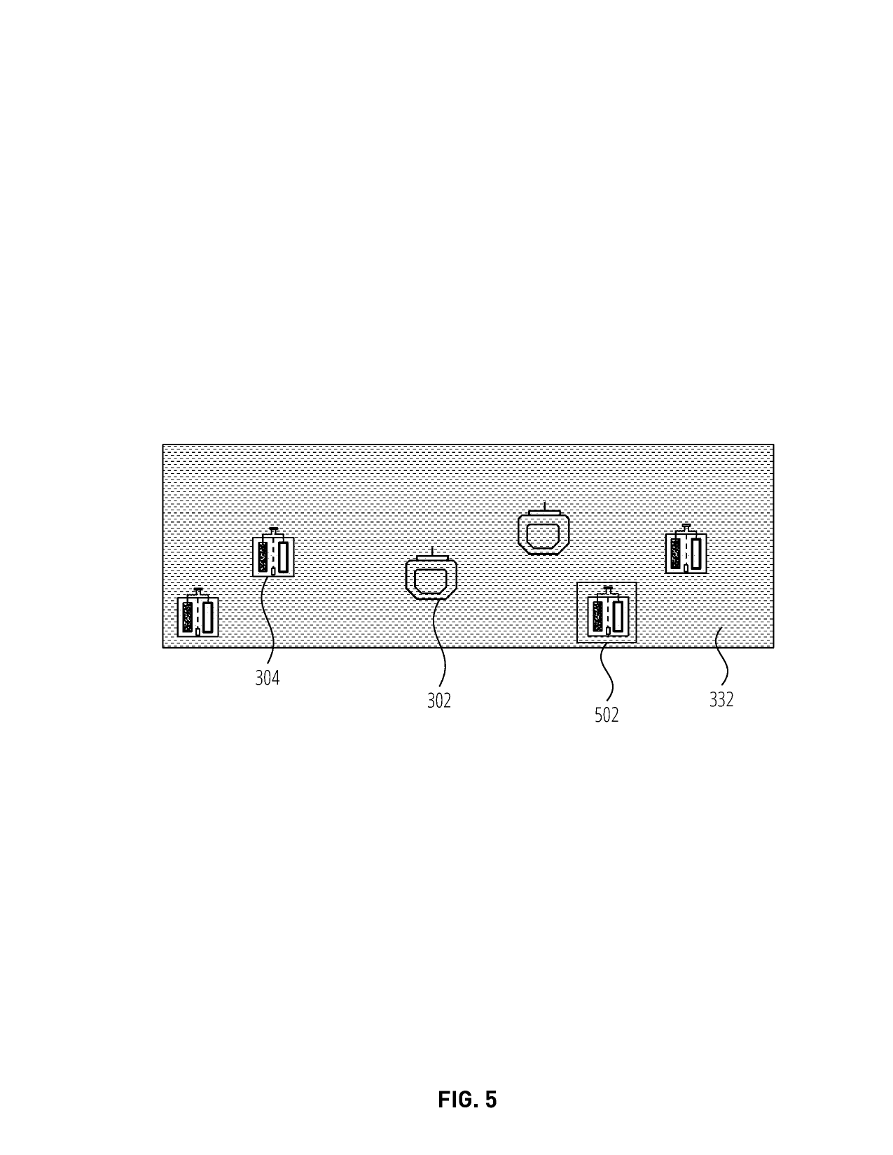

FIG. 5 illustrates a navigation operation of the underwater robotic system 300 in accordance with an illustrative embodiment. Each microbial power generation module 304 stores the generated electricity in an energy storage unit and communicates stored power levels to the underwater robot 302. This communication enables the robot 302 to assess the available power in each module before selection. The underwater robot 302 can identify and select the modules for recharging based on the communicated stored power levels and proximity received at the communication unit 324, ensuring efficient power management.

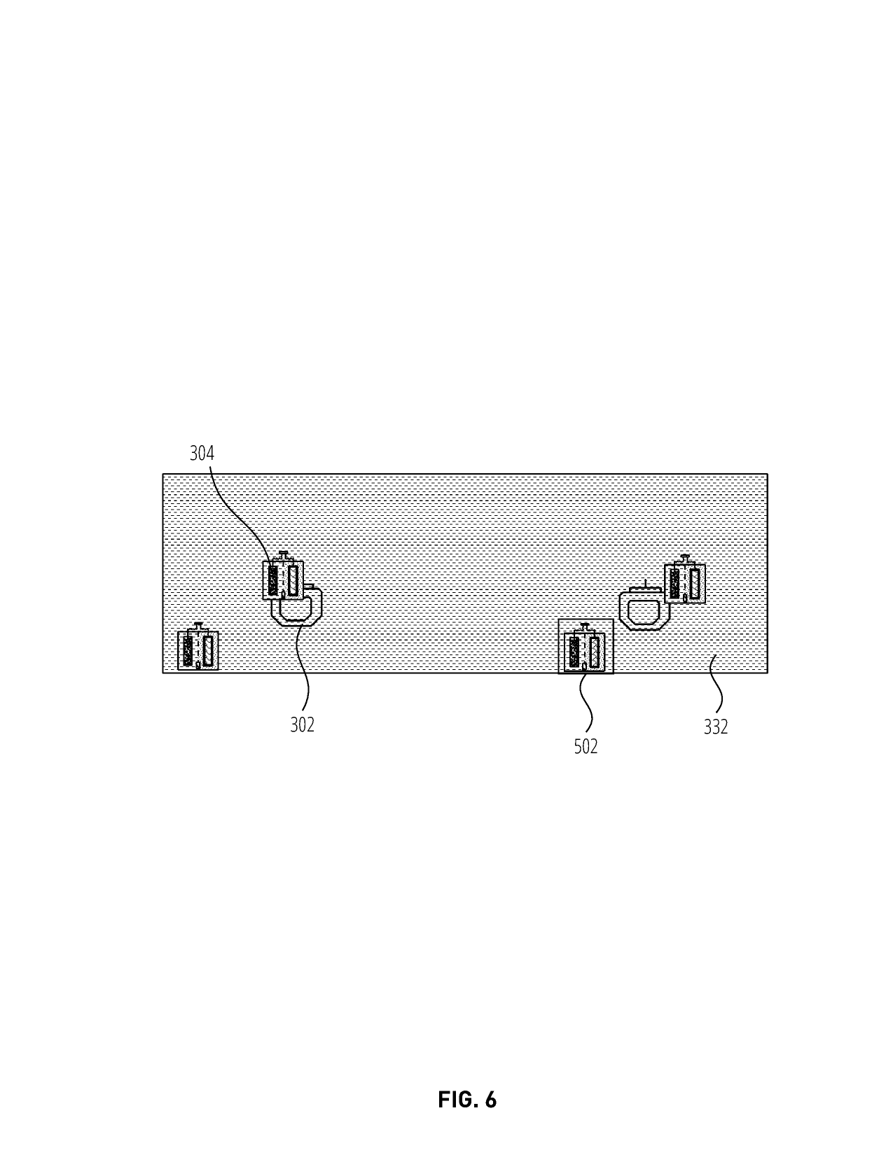

FIG. 6 depicts a recharging operation of the underwater robotic system 300 in accordance with an illustrative embodiment. While navigating and performing activities in the wastewater environment, the robot 302 may receive information about power generation (or power generation data) from microbial power generation modules 304 that may or may not be attached at different locations. The underwater robot may alternatively or in addition generate information about potential power generation patterns or capabilities of microbial power generation modules, based on contents of the wastewater at different locations. The autonomous power management engine 126, or a control unit of the underwater robot 302 may thus, identify locations of the microbial power generation modules 304 that meet an optimal power generation rate threshold for the underwater robot 302 by analysing the power generation data, which may include information such as microbial activity levels and organic matter concentration. The optimal power generation rate threshold may be a minimum rate at which power is generated by a microbial power generation module 304 and may be affected by factors such the location of the microbial power generation module 304 in the wastewater. In some examples, by placing microbial power generation modules 304 at location with high microbial activity or organic matter concentration, a minimum power generation rate may be achieved for the microbial power generation module 304. The robot 302 may then place the microbial power generation modules 304 at the identified locations to maximize power generation. The strategic placement may enhance power harvesting and ensure that energy is readily available when needed.

In an embodiment, the underwater robots 302 are configured to identify and select the microbial power generation modules 304 for recharging based on the communicated stored power levels, power generation rates, and proximity. The embodiment ensures that the underwater robots 302 can efficiently locate the most suitable modules for recharging, reducing downtime and conserving energy, thereby saving power and allowing for efficient wastewater cleaning operations.

The underwater robots 302 may be coupled to the microbial power generation modules 304 through a coupling mechanism 308 which can include one or more of a mechanical, pneumatic, electrical, or fluid couplings. Additionally, wireless charging methods suitable for underwater environments may be employed. The flexibility in coupling mechanisms may ensure reliable recharging under various conditions. The coupling mechanism 308 on the underwater robot 302 may thus match the coupling mechanism 328 on the microbial power generation modules 304 to facilitate efficient power transfer.

In yet another embodiment, while navigating and performing activities in the wastewater environment 332, the underwater robots 302 receive power generation data from the microbial power generation modules 304 at a number of locations in the wastewater environment 332. The underwater robots 302 can identify locations with optimal power generation rates and place the microbial power generation modules 304 at these identified locations to maximize power generation. The dynamic placement enhances power availability and overall system efficiency.

An underwater robot 302 may further be configured to form a swarm with other underwater robots 302 and collaboratively assemble the microbial power generation modules 304 into a grid to enhance power availability. The swarm may utilize a trained machine learning model configured to use input information about the underwater environment including one or more of information about available underwater robots 302(such as number, power demand, remaining power, location/distance from microbial power generation modules, or otherwise underwater robot information), information about microbial power generation modules (such as number, power generation rate, remaining power, location/distance from underwater robots, or otherwise microbial power generation module information) to generate output proposals about what microbial power generation module 304 to couple an underwater robot 302 with for optimal performance. Sample input and output data may be generated or simulated as test and validation data for use in training the machine learning model. Thus, machine learning model may initially be trained into the trained machine learning model based on sample test input and output data and validated with sample validation input and output data. By proposing the output with the trained machine learning model, unknown constraints that affect the choice of an optimal output may more readily be taken into consideration to optimize underwater, cleaning, and recharging efficiency. Thus, the underwater robots 302 can communicate with each other or with a central module such as the autonomous power management engine 126 to determine which charging stations 502 (see FIG. 5) have sufficient charging capacity and navigate to the nearest suitable station. This collaborative approach improves resource utilization and operational effectiveness.

In embodiments, the underwater robots 302 may continuously self-evaluate power demands. Responsive to an underwater robot 302 determining new additional power demands, the underwater robot 302 may find a nearest charging station 502 or microbial power generation module 304 with sufficient power storage or generating capacity for recharge. This decision is based on factors such as stored power levels, power generation rates, and proximity, ensuring efficient recharging without unnecessary travel.

In scenarios where wastewater flow is low or stationary, the charging stations 502 may create artificial flow, enhancing microbial activity and power generation. The continuous power generation by the microbial power generation modules 304 allows the underwater robots 302 to continue tasks and better manage resources and time. Underwater robots 302 can work underwater and navigate to the charging stations 502 for recharging as needed.

In one or more embodiments, the microbial power generation modules 304 and associated batteries do not use lithium, reducing the risk of fire and enhancing safety in underwater environments. The system, including the underwater robots 302 and microbial power generation modules 304, may incorporate cooling and exhaust mechanisms to maintain optimal operating temperatures.

In an embodiment, the microbial power generation modules 304 are designed as portable, battery-sized units. The microbial power generation modules 304 include one or more microbial fuel cells 320 configured to generate electricity through microbial electrogenesis by oxidizing organic matter present in the wastewater environment 332, energy storage unit 322 which stores the harvested power for later use, communication unit 314 that communicates stored power levels and power generation rates to the underwater robots 302, power transmission module 330 that facilitates power transfer to the underwater robots 302 when coupled and coupling mechanism 328 that allows physical or wireless coupling with the underwater robots 302.

The microbial power generation modules 304 utilize microorganisms that oxidize organic matter, releasing electrons and protons. The electrons may be transferred to the anode electrode of the microbial fuel cell 320, flow through an external circuit to the cathode, creating an electric current. This sustainable and renewable approach provides simultaneous wastewater treatment and electricity generation.

In one or more embodiments, the coupling mechanisms 308 and 328 may further include mechanical couplings such as threaded connections, clamps, or quick-release mechanisms for secure attachment, pneumatic couplings such as quick-connect fittings and valves using compressed air or gases, electrical couplings such as connectors or plug-and-play interfaces for reliable electrical connections, fluid couplings such as leak-free connections for transferring liquids or gases and wireless charging methods such as inductive or resonant coupling suitable for underwater environments. The underwater robots 302 and microbial power generation modules 304 are designed to ensure compatibility of coupling mechanisms for efficient power transfer.

In one or more embodiments, the underwater robots 302 evaluate the power generation rating and self-weight of the microbial power generation modules 304 at specific intervals. The underwater robots 302 assess the increase in weight and rate of recharge when considering attaching a module 304. The underwater robots 302 decide whether to carry the modules 304 or place them at optimal locations based on this evaluation. Carrying a module 304 may consume both stored battery power and ongoing generation, but may affect mobility due to increased weight.

### Example Use Cases

Use Case 1: Continuous Power Supply During Mobility - An underwater robot 302 tasked with removing sedimentation over a large area may be configured to evaluates the available microbial power generation modules 304 in a vicinity. The underwater robot 302 selects a module 304 with a suitable power generation rate and manageable weight. The underwater robot 302 couples with the module 304 using an electrical coupling mechanism 308. While carrying the module 304, the underwater robot 302 receives continuous power supply from both the stored energy and ongoing microbial electrogenesis, allowing the underwater robot 302 to perform its tasks without interruption, enhancing operational efficiency.

Use Case 2: Optimizing Power Generation Through Module Placement - A swarm of underwater robots 302 may be deployed in a wastewater treatment facility. As the swarm navigates, the swarm collects power generation data from different locations within the wastewater environment 332. The underwater robots 302 identify specific areas where microbial activity and the power generation is highest. The underwater robots 302 collaboratively decide to place multiple microbial power generation modules 304 at these optimal locations, forming a grid. The underwater robots 302 adjust the positions of the modules 304 to maximize power generation. Underwater robots 302 in need of recharging navigate to this grid and couple with the modules 304 to replenish power reserves, ensuring efficient energy utilization.

Use Case 3: Decision Against Carrying Modules in Constrained Environments - An underwater robot 302 may be assigned to clean a blockage in a narrow pipe and may evaluates the power generation rate and weight of available microbial power generation modules 304. The underwater robot 302 determines that carrying a module 304 would impede mobility due to spatial constraints. The underwater robot 302 decides to rely on onboard rechargeable battery 320 (also referred to as microbial fuel cell) for the task and plans to recharge afterward by coupling with a stationary microbial power generation module 304 placed at a convenient location outside the pipe. The decision allows the underwater robot 302 to effectively perform its task without hindrance while ensuring it can recharge upon completion.

Use Case 4: Swarm Coordination for Efficient Cleaning and Recharging - Underwater robots 302 may form a swarm to efficiently manage cleaning tasks and power resources within the wastewater environment 332. Using AI-generated methods (such as a trained machine learning model), the underwater robots 302 may classify the wastewater surroundings to prioritize areas requiring cleaning. The underwater robots 302 may coordinate movements to avoid overlap and ensure comprehensive coverage. The swarm communicates to determine which charging stations 502 have sufficient charging capacity. Underwater robots 302 with low power levels navigate to the nearest suitable charging station 502, reducing downtime and optimizing resource utilization.

Use Case 5: Dynamic Adjustment of Charging Stations Based on Wastewater Flow - In a scenario where the wastewater flow is uneven, the underwater robots 302 may collect data indicating that certain areas have reduced microbial activity due to low flow rates. To address this, the underwater robots 302 relocate some microbial power generation modules 304 to areas with higher flow rates, enhancing power generation. Alternatively, the underwater robots 302 may activate mechanisms within the charging stations 502 to create artificial flow, stimulating microbial activity. The dynamic adjustment ensures that the charging infrastructure remains efficient, and the underwater robots 302 have continuous access to power.

### Example Operational Scenarios

Scenario 1: Emergency Power Management - In the event of an unexpected power shortage due to a sudden drop in microbial activity, underwater robots 302 communicate to redistribute power resources. The underwater robots 302 may prioritize critical tasks and may temporarily suspend non-essential activities. Underwater robots 302 with higher power reserves may be configured to assist those with lower reserves by sharing power through direct coupling, ensuring critical operations to continue.

Scenario 2: Maintenance of Charging Station - Underwater robots 302 may perform routine maintenance on charging stations 502 and microbial power generation modules 304. The underwater robots 302 may clean the modules 304 to ensure optimal microbial activity. The maintenance extends the lifespan of the modules 304 and maintains consistent power generation rates.

Scenario 3: Adaptation to Environmental Changes - Underwater robots 302 may be configured to monitor environmental parameters such as temperature, pH levels, and pollutant concentrations. If changes are detected that affect microbial electrogenesis, underwater robots 302 adjust their strategies accordingly. The underwater robots 302 may relocate modules 304 to areas with more favorable conditions or adjust their operational parameters to compensate for reduced power generation.

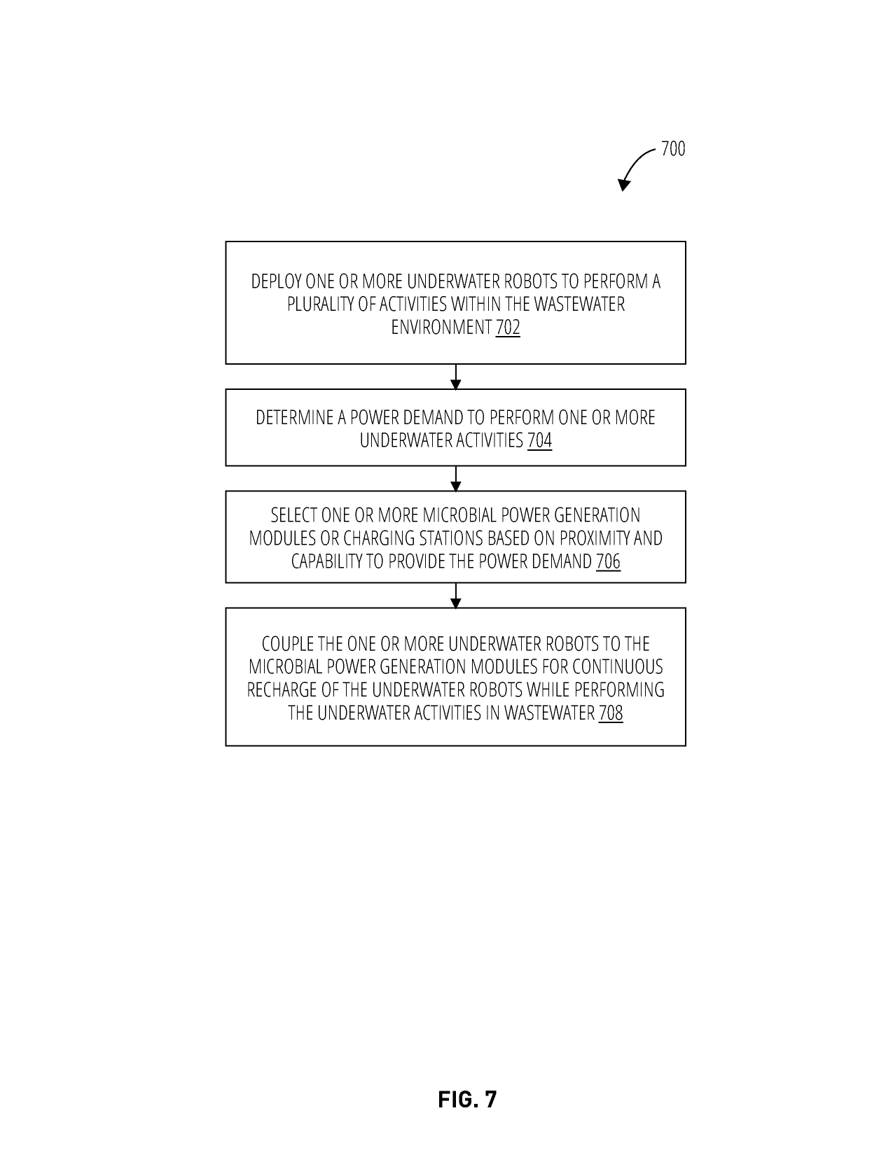

Reference is now made to FIG. 7, which illustrates a flowchart of a routine 700 of operating a plurality of underwater robots 302 in a wastewater environment 332 in accordance with one or more embodiments. The routine may be performed with the autonomous power management engine 126. At step 702, the autonomous power management engine deploys the underwater robots 302 and a plurality of microbial power generation modules 304 within the wastewater environment 332. Charging stations 502 may be strategically placed at different underwater locations to facilitate efficient recharging. At step 704, the autonomous power management engine 126 determines a power demand for one or more underwater robots 302 or a to perform one or more underwater activities. The underwater robots 302 may in some embodiments independently self-evaluate power levels and power demands. At step 706, the autonomous power management engine 126 selects one or more microbial power generation modules 304 or charging stations 502 based on proximity and capability metric to provide the power demand for the one or more underwater robots 302. At step 708, the autonomous power management engine 126 couples one or more underwater robots 302 couples with the one or more selected microbial power generation modules 304 or charging stations 502 to receive power while performing underwater activities. The coupling can be achieved through physical connections or wireless charging methods suitable for underwater environments. This approach allows underwater robots 302 to recharge without significantly interrupting their tasks.

In an embodiment, the routine 700 further comprises evaluating, by the underwater robots 302, based on the power generation rate and weight of the coupled microbial power generation modules 304, whether to carry or place the modules 304 at selected locations within the wastewater environment 332 to optimize power availability. Underwater robots 302 may decide to leave modules 304 at locations with optimal power generation rates to serve as charging stations 502 for themselves and other underwater robots 302, enhancing overall efficiency.

In an embodiment, the routine 700 further includes forming a swarm with other underwater robots 302. The underwater robots 302 collaboratively assemble the microbial power generation modules 304 into a grid, creating an efficient network of charging stations 502. The underwater robots 302 use a trained machine learning model to classify the wastewater surroundings, plan cleaning tasks, and optimize recharging schedules. Underwater robots 302 communicate stored power levels and power generation rates among the swarm, allowing them to navigate to the nearest station with sufficient charging capacity.

Additionally, the routine 700 comprises receiving power generation data from multiple locations within the wastewater environment 332. The underwater robots 302 identify locations with optimal power generation rates and adjust positions of the microbial power generation modules 304 or charging stations 502 to these identified locations to maximize power generation. The dynamic adjustment ensures that the charging infrastructure remains efficient even as environmental conditions change.

The underwater robotic system 300 and routine 700 described provide several technical advantages as follows. By utilizing microbial power generation modules 304 that harness energy through microbial electrogenesis, the underwater robots 302 reduce reliance on surface-level recharging and eliminate the need to be frequently pulled up, thus maintaining continuous underwater operation. The placement of charging stations 502 underwater allows underwater robots 302 to recharge efficiently without significant downtime. The underwater robots 302 can evaluate power demands and make intelligent decisions about where and when to recharge, considering factors such as stored power levels, power generation rates, and proximity to charging stations 502.

The use of swarm robot technology and enables underwater robots 302 to classify the wastewater surroundings, optimize cleaning tasks, and manage recharging effectively. The collaborative approach enhances operational efficiency and resource utilization. Further, the system can dynamically adjust to environmental changes and operational constraints, enhancing robustness and effectiveness. Underwater robots 302 can relocate modules 304 based on microbial activity and environmental conditions. The microbial power generation modules 304 and associated batteries do not use lithium, reducing fire risks and enhancing safety. The system, including the underwater robots 302 and modules 304, may incorporate cooling and exhaust mechanisms to maintain optimal operating temperatures. In addition, the system supports both physical and wireless charging methods suitable for underwater environments, providing flexibility and reliability.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An underwater robotic system comprising:
a plurality of underwater robots configured to perform a plurality of underwater activities in a wastewater environment; and
a plurality of microbial power generation modules operatively associated with the plurality of underwater robots; and
at least one processor configured to:
determine a power demand for an underwater robot of the plurality of underwater robots to perform an underwater activity of the plurality of underwater activities;
select at least one microbial power generation module of the plurality of microbial power generation modules, based on at least a proximity of the at least one microbial power generation modules to the underwater robot and a capability of the at least one microbial power generation modules to provide the power demand; and
cause the underwater robot to couple with the at least one microbial power generation module to receive power while performing the underwater activity.

2. The system of claim 1, wherein the underwater robot is configured to evaluate, based on a power generation rate and a weight of the coupled at least one microbial power generation module, information about carrying or placing the coupled at least one microbial power generation module at a selected location within the wastewater environment to optimize power availability.

3. The system of claim 1, wherein each microbial power generation module of the plurality of microbial power generation modules are configured to generate power through microbial electrogenesis by oxidizing organic matter present in the wastewater environment.

4. The system of claim 1, wherein each microbial power generation module of the plurality of microbial power generation modules comprises an energy storage unit configured to store power.

5. The system of claim 1, wherein each microbial power generation module of the plurality of microbial power generation modules includes a communication unit configured to transmit a stored power level and a power generation rate to one or more underwater robots of the plurality of underwater robots.

6. The system of claim 5, wherein one or more underwater robots of the plurality of underwater robot is configured to identify and select one or more microbial power generation modules of the plurality of microbial power generation modules for recharging based on factors selected from one or more of a stored power level, a power generation rate and a proximity.

7. The system of claim 1, wherein the underwater robot is configured to be coupled to the at least one microbial power generation module through a coupling mechanism comprising at least one of a mechanical, a pneumatic, an electrical, or a fluid coupling.

8. The system of claim 1, wherein the underwater robot is configured to:
receive, while navigating and performing the plurality of underwater activities in the wastewater environment, power generation data from one or more microbial power generation modules of the plurality of microbial power generation modules at a plurality of locations;
identify one or more locations of the plurality of locations that enable the one or more microbial power generation modules to meet an optimal power generation rate threshold;
and place the one or more microbial power generation modules at the identified one or more locations to maximize power generation.

9. The system of claim 1, wherein the plurality of underwater robots is configured to form a swarm and collaboratively assemble the microbial power generation modules into a grid to enhance power availability.

10. The system of claim 1, wherein the underwater robot is configured to remove sedimentation, clean blockages, or create a vortex flow to impede sedimentation.

11. A method of operating a plurality of underwater robots in a wastewater environment, comprising:
deploying the plurality of underwater robots and a plurality of microbial power generation modules within the wastewater environment;
determining a power demand for an underwater robot of the at plurality of underwater robots to perform an underwater activity of the plurality of underwater activities;
selecting at least one microbial power generation module based on at least a proximity of the at least one power generation module to the underwater robot and a capability of the at least one microbial power generation module to provide the power demand; and
coupling the underwater robot, with the selected at least one microbial power generation modules to receive power while performing the underwater activity.

12. The method of claim 11, further comprising:
generating information, based on a power generation rate and a weight of the coupled at least one microbial power generation module, about carrying or placing the at least one microbial power generation module at a selected location within the wastewater environment to optimize power availability; and
positioning the at least one microbial power generation module at the selected location.

13. The method of claim 11, further comprising:
forming a swarm of underwater robots using the plurality of underwater robots;
collaboratively assembling, using the swarm, the plurality of microbial power generation modules into a grid;
providing stored power levels and power generation rates of the plurality of microbial power generation modules to the swarm.

14. The method of claim 11, wherein at least one underwater robot of the plurality of underwater robots receive power from the microbial power generation modules through a wired or wireless connection.

15. The method of claim 11, wherein the plurality of underwater robots perform underwater activities including at least one of: (i) removing sedimentation, (ii) cleaning blockages, (iii) or creating vortex flows to prevent sedimentation.

16. The method of claim 11, further comprising:
generating, using the plurality of microbial power generation modules, power through microbial electrogenesis by oxidizing organic matter present in the wastewater environment.

17. The method of claim 11, further comprising:
receiving power generation data from one or more microbial power generation modules of the plurality of microbial power generation modules at a plurality of locations within the wastewater environment;
identifying one or more locations of the plurality of locations that enable the one or more microbial power generation modules to meet an optimal power generation rate threshold; and
adjusting positions of the plurality of microbial power generation modules to the identified one or more locations to maximize power generation.

18. A computer program product for managing operations of a plurality of underwater robots in a wastewater environment, the computer program product comprising:
one or more computer-readable storage devices and program instructions stored on the at least one of the one or more computer-readable storage devices, the program instructions executable by a processor, the program instructions comprising:
program instructions to deploy the plurality of underwater robots and a plurality of microbial power generation modules withing the wastewater environment;
program instructions to determine a power demand for an underwater robot of the plurality of underwater robots to perform an underwater activity of the plurality of underwater activities;
program instructions to select at least one microbial power generation module based on at least a proximity of the at least one microbial power generation module to the underwater robot and a capability of the at least one microbial power generation module to provide the power demand; and
program instructions to couple the underwater robot with the selected at least one microbial power generation module to receive power while performing the underwater activity.

19. The computer program product of claim 18, wherein the program instructions further comprise:
program instructions to generate information, based on a power generation rate and a weight of the at least one coupled microbial power generation modules, about carrying or placing the at least one microbial power generation module at a selected location within the wastewater environment to optimize power availability; and
program instructions to position the at least one microbial power generation module at the selected location.

20. The computer program product of claim 18, wherein the program instructions further comprise:
program instructions to form a swarm of underwater robots using the plurality of underwater robots;
program instructions to collaboratively assemble, using the swarm, the plurality of microbial power generation modules into a grid;
program instructions to provide stored power levels and power generation rates of the plurality of microbial power generation modules to the swarm.
